(19) United States
(12) Patent Application Publication
(10) Pub. No.: US 2005/0151800 A1
(43) Pub. Date: Jul. 14, 2005

(54) Ink jet recording apparatus

(76) Inventors: Takeshi Kono, Kanagawa (JP); Mitsuru Kurata, Kanagawa (JP); Akihiro Yamanaka, Kanagawa (JP); Takeaki Shima, Kanagawa (JP); Tetsuto Kageyama, Kanagawa (JP); Itaru Watanabe, Kanagawa (JP); Hiroki Tajima, Kanagawa (JP); Toshihiro Sasaki, Kanagawa (JP)

Correspondence Address: FITZPATRICK CELLA HARPER & SCINTO, 30 ROCKEFELLER PLAZA, NEW YORK, NY, 10112, US

(21) Appl. No.: 10/078,457

(22) Filed: Feb. 21, 2002

(30) Foreign Application Priority Data
Feb. 23, 2001 (JP) 048667/2001
Feb. 23, 2001 (JP) 048671/2001

(51) Int. Cl. B41J 2/175

(52) U.S. Cl. 347/85

(57) ABSTRACT

An ink jet recording apparatus comprises a recording head including a discharge port for discharging ink, a first liquid chamber at the upstream side in the direction of ink flow toward the discharge port, and a second liquid chamber at the downstream side, an ink tank for containing ink to be supplied to the recording head, an ink supply tube for causing the ink tank to communicate with the recording head, a shut-off valve provided in the ink supply tube and opening or closing the ink supply tube, a cap for covering the discharge port; and a suction pump for forcedly discharging the ink in the recording head from the discharge port when the cap covers the discharge port. The shut-off valve is opened when the first and second liquid chambers are reduced to respectively desired pressures by the suction pump in a state where the cap covers the discharge port and the shut-off valve is closed, whereby the ink in the ink tank is supplied through the ink supply tube to the first and second liquid chambers.

### BACKGROUND OF THE INVENTION

1. Field of the Invention

The present invention relates to an ink jet recording apparatus.

2. Related Background Art

The recording apparatus for recording on a recording medium conventionally employs various recording methods such as wire dot method, thermal recording method, thermal transfer recording method, ink jet method etc. Among these methods, the ink jet recording method for forming a record on a recording medium by discharging small ink droplet from a discharge port (nozzle) is widely employed in recent years because it is a non-impact recording method with various advantages such as scarce noise generation at recording, and capability of executing high-density and high-speed recording on various recording media.

An ink jet recording apparatus is generally provided with an ink jet recording head, means for conveying the recording medium, and control means for controlling these components. The method for generating energy for ink discharge from the nozzle of the ink jet recording head can be, for example, pressurization of ink with an electromechanical converting element such as a piezo element, bubble generation by irradiation with electromagnetic wave for example from a laser, bubble generation by liquid heating with an electrothermal converting element such as a heat generating resistor etc. Among these, a method for discharging ink droplet by thermal energy (bubble jet method) can achieve recording of high resolution because the energy generating means can be arranged at a high density. Particularly an ink jet recording head utilizing an electrothermal converting element as the energy generating means can be made compact and provides advantages of easily achieving high-density configuration and low manufacturing cost, utilizing the IC technology and the microfabrication technology showing remarkable progress and improvement in reliability in the semiconductor area.

The ink jet recording apparatus representing the background technology and shown in FIG. 6 is a recording apparatus of serial type, in which the recording head is mounted on a carriage (not shown) and the recording operation is executed by the movement of such carriage, employing so-called tube supply system in which the recording head is connected with a main tank through a tube. Such ink jet recording apparatus is provided with a main tank (ink tank) 104 for containing ink, a recording head 101 for discharging ink droplet by thermal energy, an ink supply unit 105 and an ink supply tube 106 for ink supply from the main tank 104 to the recording head 101, an air discharge tube 110a, a shut-off valve 110b and an air discharge pump 110c for opening the recording head 101 to the air, and a recovery unit 107 for a recovery process for the recording head 101.

At first there will be explained the schematic configuration of the recording head 101. A discharge nozzle 101g in the recording head 101 is composed of a fine hole. The nozzle 101g is not provided with a valve mechanism, and ink leakage from the nozzle 101g no or air intrusion therein is prevented by maintaining the interior of the nozzle at a negative pressure thereby forming an ink meniscus at the front end of the nozzle. More specifically, since the nozzle 101g is open to air and the aperture of the nozzle 101g is positioned downwards, the interior thereof has to be maintained at a negative pressure in order to prevent ink leakage therefrom. On the other hand, an excessive large negative pressure causes air to enter the nozzle 101g, thereby disabling the ink discharging operation. Therefore, in order to maintain the interior of the recording head 101 at an appropriate negative pressure state, the recording head 101 is so positioned that the aperture of the nozzle 101g is higher by a height H than the ink liquid level in an ink chamber 105f to be explained later, thereby maintaining the interior of the recording head 101 at a negative pressure corresponding to a water head of a height H. Thus the nozzle 101g is maintained in a state filled with ink by forming a meniscus at the aperture.

The ink discharge is executed by pushing out the ink in the nozzle 101g by film boiling energy generated by an unrepresented heater (heat generating resistor) positioned in the vicinity of the nozzle 101g. After the ink discharge, the ink is replenished into the nozzle 101g by the capillary force thereof and is thus sucked up from time to time from the main tank 104 through the ink supply tube 106. Such ink discharge and ink supply (refilling) are repeated.

In the interior of the recording head 101, there are provided a filter 101c of fine mesh structure for preventing clogging of the fine hole of the nozzle 101g with particles, a flow path 101f finely branched for connecting the filter 101c with the nozzles 101g, and a sub tank 101b for containing a predetermined amount of ink at the upstream side of the filter 101c, whereby the ink flowing in from the ink supply tube 106 is supplied to the nozzle 101g.

In the following there will be explained the schematic configuration of the main ink 104 and the ink supply unit 105. The configuration is substantially same as that disclosed for example in the Japanese Registered Patent No. 2929804, wherein a hollow ink supply needle 105a and a hollow air introducing needle 105b fixed to the ink supply unit 105 penetrate a connector 104b at the bottom of the main tank 104 and enter the main tank 104. Inside the ink supply unit 105, there is provided an ink tank chamber 105f which is open to the air by an air communicating aperture 105g, and the needles 105a, 105b are positioned therein so as to be immersed, with different lower end heights in the ink. The bottom of the ink chamber 105f communicates with the ink supply tube 106, and, along with the ink consumption, the ink in the ink chamber 105f decreases whereby the lower end of the air introducing needle 105b is separated from the ink and is exposed to the air. Thus the air introduced from the lower end of the air introducing needle 105b into the main tank 104 and the ink in the main tank 104 flows to the ink chamber 105f. When the liquid level in the ink chamber 105f rises by such ink flow, the lower end of the air introducing needle 105f is again immersed in the ink, thereby terminating the air introduction into the main tank 104 and the ink flow into the ink chamber 105f. In this manner the ink in the ink tank 104 is gradually taken out.

In the lower part of the main tank 104, an electrode 104e is provided in contact with the ink, thus in electric conduction with a contact 104j provided in the ink supply unit 105. Between the contact 105j and the air introducing needle 105b, there is connected a detection circuit including a detector 105h for measuring the electric resistance of the ink. The presence or absence of the ink can be detected by measuring the electric resistance of the ink by such detection circuit.

In the following there will be explained the air discharge tube 110a, the shut-off valve 110b and the air discharge pump 110c. In the sub tank 101b of the recording head 101, there may be accumulated air that permeates through a resinous material for example of the ink supply tube 106 or is dissolved in the ink. Therefore, thus accumulated excessive air is periodically discharged, together with the ink, from a lateral portion of the sub tank 101b, by suction with the air discharge tube 110a and the air discharge pump 110c. Upon completion of the air discharge, the air discharge path is closed by the shut-off valve 110b.

In the following there will be explained the recovery unit 107. In case the discharge nozzle 101g is clogged with viscosified ink or with excessive bubbles generated at the ink discharge, the recovery unit 107 is used for eliminating such viscosified ink or bubbles by contacting a suction cap 107a with the recording head 101, and sucking the ink, together with the viscosified ink and bubbles, strongly from the nozzle 101g by a suction pump thereby recovering the function of the recording head 101.

In the ink jet recording apparatus of the aforementioned background technology, there is known a phenomenon, in case of ink discharge for recording by bubble generation of the air dissolved in the ink by heat generation in a heater corresponding to the nozzle 101g, that bubbles are gradually accumulated in the flow path 101f by fission of the generated bubble and accumulation thereof in the flow path 101f under the filter 101c or by gathering of fine bubbles present in the ink by a temperature increase around the heater.

In the configuration of the aforementioned background technology, since the flow path 101f is narrowly formed, the ink flow tends to become stagnant therein so that the movement of the bubble is retarded. The strong suction by the recovery unit 107 increases the ink flow speed whereby the ink and bubbles in the flow path 101f can be discharged, but, if the bubble grows to a size completely interrupting the flow path 101f, the ink supply to the nozzle 101g is hindered, so that the suction by the recovery unit 107 has to be executed frequently to discharge the bubble before it grow excessively. Therefore, the amount of ink wasted at each suction inevitably increases.

On the other hand, if the flow path 101f is formed thicker so as not to be interrupted or clogged by the bubble, the bubble rises to the upper part of the flow path 101f and the suction, even if executed strongly, from the nozzle 101g by the recovery unit 107 can only suck out the ink and cannot discharge the bubble by suction. Also, since the filter 101c has a fine mesh structure, and the ink entering each pore of the mesh forms a meniscus therein which cannot be penetrated by the air. Thus the bubble cannot escape to the sub tank 101b but accumulates in the upper part of the flow path 101f. Such bubble accumulation increases the volume occupied by the air in the flow path 101f, thus leading to an ink amount decrease therein, which leads to the exposure, to the air, of the ink supply aperture at the upper face of the nozzle 101g, eventually resulting in a situation in which the ink supply thereto is disabled.

Particularly in recent years, as a result of increase in the number of nozzles and in the driving rate (ink discharge at a higher drive frequency) in the recording head, the bubble generation at the printing operation is increasing in general. The ink consumption per unit time becomes therefore larger, so that the fine flow path as employed in the background technology leads to a larger pressure loss, thus resulting in a discharge failure.

### SUMMARY OF THE INVENTION

An object of the present invention is to provide an ink jet recording apparatus capable of preventing a significant reduction in the ink amount in the recording head or the interruption of the flow path in the recording head by the bubble, and also of reducing the wasted ink discharge amount not contributing to the recording, in the recovery process.

Another object of the present invention is to provide an ink jet recording apparatus comprising a recording head including a discharge port for discharging ink, a first liquid chamber provided at the upstream side in the direction of ink flow toward the discharge port and a second liquid chamber at the downstream side, an ink tank for containing the ink to be supplied to the recording head, an ink supply tube connecting the ink tank and the recording head, a shut-off valve provided in the ink supply tube for opening or closing the ink supply tube, a cap for covering the discharge port, and a suction pump for forcedly discharging the ink in the recording head from the discharge port when it is covered by the cap, wherein the shut-off valve is opened after the first and second liquid chambers are reduced to respectively desired pressures by the suction pump in a state where the shut-off valve is closed and the discharge port is covered by the cap, whereby the ink in the ink tank is supplied through the ink supply tube to the first and second liquid chambers.

In this manner the two divided liquid chambers can be filled with the ink and can therefore contain the ink of appropriate amounts. Thus, even in case of employing a wider liquid path in the recording head, it is possible to extract the air from the liquid chambers and to replenish ink therein. It is also rendered possible to prevent prolonged ink deficiency in the both liquid chambers, so that the frequency of the recovery operation can be reduced to decrease the wasted ink amount. The ink amount can be further saved because there is only required a single filling process even in case the ink filling is required in both liquid chambers.

Another feature of the present invention lies in that the volume V1 of the first liquid chamber is so selected as to substantially satisfy a relation V1=S1/|p1|, wherein p1 (atm) is the reduced pressure in the first liquid chamber at the suction operation (relative value from the atmospheric pressure), and S1 is the ink amount to be present in the first liquid chamber. Still another feature of the present invention lies in that the volume V2 of the second liquid chamber is so selected as to substantially satisfy a relation V2=S2/|p2|, wherein p2 (atm) is the reduced pressure in the second liquid chamber at the suction operation (relative value from the atmospheric pressure), and S2 is the ink amount to be present in the second liquid chamber. Thus the ink can be filled in such a manner that the liquid chambers respectively contain ink of appropriate amounts, utilizing the law PV=constant.

Between the first and second liquid chambers, there is preferably provided a filter for separating the two. The filter may have a mesh structure having a plurality of pores. It is preferable to set the parameters so as to satisfy a relation p1=p2−pm wherein pm is the pressure of the ink meniscus strength in each pore of the filter, p1 (atm) (relative value from the atmospheric pressure) is the reduced pressure in the first liquid chamber at the suction operation, and p2 (atm) (relative value from the atmospheric pressure) is the reduced pressure in the second liquid chamber at the suction operation, also to set the volume V1 of the first liquid chamber so as to satisfy a relation V1=S1/|p1| wherein S1 is the ink amount to be present in the first liquid chamber, and to set the volume V2 of the second liquid chamber so as to satisfy a relation V2=S2/|p2| wherein S2 is the ink amount to be present in the second liquid chamber.

More specifically, as the ink penetrates the filter of fine mesh structure, a fine meniscus is formed in each pore of the filter, whereby the ink can easily pass through the filter but the air cannot easily pass. As the mesh becomes finer, the meniscus strength becomes larger to reduce the permeability to the air, whereby a pressure pm is required for air permeation. This pressure pm can be determined experimentally. In case of suction from the nozzle by the recovery unit, the pressure p2 in the second liquid chamber, involving air permeation of the sub tank through the filter, becomes lower than that p1 in the first liquid chamber by the pressure pm corresponding to the meniscus strength. The parameters can be easily determined by utilizing this relationship in determining the volumes of the liquid chambers.

The ink amounts to be present in the first and second liquid chambers are preferably larger than the air amounts to be accumulated in the first and second liquid chambers, and also larger than the sum of the air amounts to be respectively accumulated in the first and second liquid chambers and the minimum ink amounts respectively required for securing the stable performance in the first and second liquid chambers.

By filling the ink in such a manner that the first liquid chamber contains an ink amount larger than the minimum ink amount (required to immerse the filter securely in the ink) and larger than the sum of the air amount accumulated therein in a predetermined period (a prolonged period such as a month) and that the second liquid chamber contains an ink amount larger than the minimum ink amount (required to immerse the nozzle securely in the ink) and larger than the sum of the air amount accumulated therein in the same predetermined period, the filling operation can be executed only one in such predetermined period, whereby the amount of the discharged ink can be saved.

Besides, there is adopted a configuration in which the cap and the shut-off valve are driven in linkage by common drive means to provide an effect that the valve does not require the drive source other than that for the suction means, whereby the cost of the ink jet recording apparatus can be reduced. Also it is no longer necessary to provide the separate drive means for the valve and the suction means, so that the drive means can be controlled by a simple sequence.

Furthermore, in case the drive means is capable of moving the cap means for covering the ink discharge face of the recording head in a capping position in contact with the ink discharge face and in a retracted position separated from the ink discharge face, a valve member constituting the valve can be so constructed as to execute a reciprocating motion whereby the motion of the cap means can be made similar to that of the valve, so that the drive means for moving the cap means and reasonably utilized also as the drive means for the valve.

Furthermore, by adopting a configuration in which a first cam for moving the cap means and a second cam for opening or closing the valve are rotated on a common shaft by a driving motor, there is provided an advantage that the sequential control of the suction means and the valve can be achieved by a simple control of rotating such motor in a single direction by a predetermined angle at a time.

Furthermore, by constructing the mounting portion of the ink tank, the valve and the connecting tube for connecting the valve to the recording head as a supply unit separate from the suction means and detachable from the main body of the recording apparatus without disassembling the flow path, and by adopting a configuration in which supply unit is positioned adjacent to the suction means and the valve is driven, either through a cam or a link, by the drive means for driving the suction means, it is rendered possible to avoid ink leakage at the disassembling of the components at the repair of the recording apparatus, and to ensure reliability against ink leakage etc. in the connecting portion of the flow paths in the ink supply path.

### BRIEF DESCRIPTION OF THE DRAWINGS

FIG. 1 is a perspective view showing the schematic configuration of an ink jet recording apparatus constituting an embodiment of the present invention;

FIG. 2 is a view showing the principle of ink supply in the ink jet recording apparatus shown in FIG. 1;

FIG. 3 is a view showing an ink supply path for a color in the ink jet recording apparatus shown in FIG. 1;

FIG. 4A, 4B, 4C and 4D are views showing the behavior of air and ink in the liquid path of an ink supply unit, at the air introduction into a main tank in the ink supply path shown in FIG. 3;

FIG. 5 is a view showing the pressure on the nozzle by the water head in the ink supply path shown in FIG. 3;

FIG. 6 is a view showing an ink supply system in an ink jet recording apparatus of tube supply system representing a background technology; and

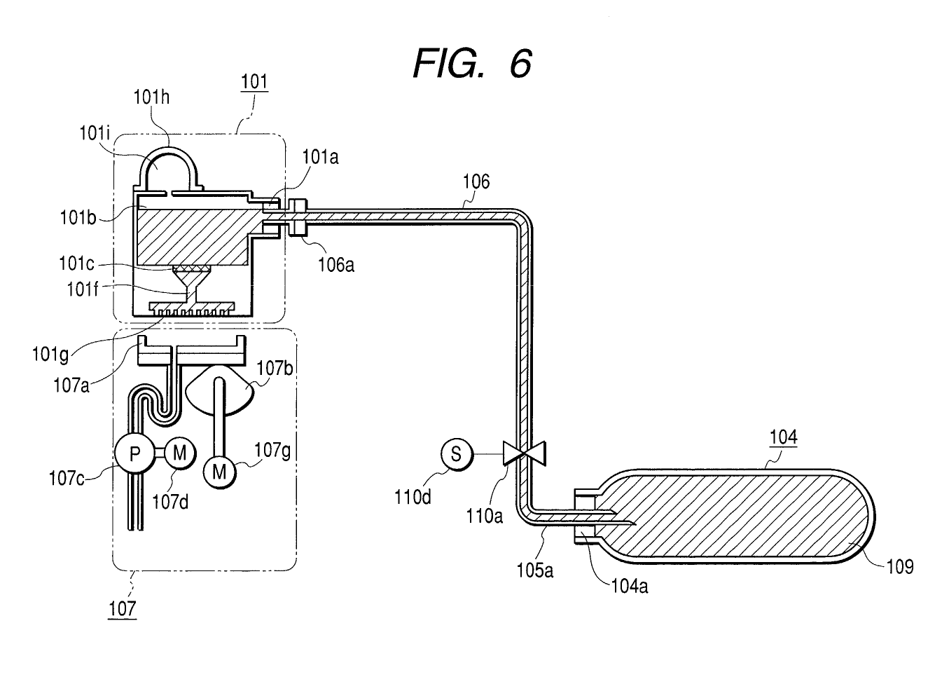

FIG. 7 is a partial perspective view schematically showing the configuration of an ink discharge portion of the recording head.

### DETAILED DESCRIPTION OF THE PREFERRED EMBODIMENTS

Now the present invention will be clarified in detail by embodiments thereof with reference to the accompanying drawings.

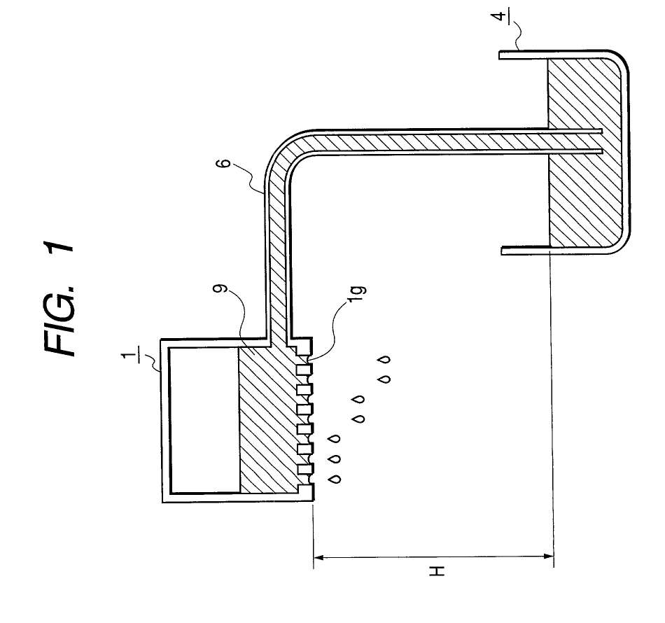

FIG. 1 is a perspective view showing the schematic configuration of an ink jet recording apparatus constituting an embodiment of the present invention. The ink jet recording apparatus of the present embodiment is a recording apparatus of serial type for forming a character, a symbol, an image etc. by repeating the reciprocating motion (main scanning) of a recording head 201 and the conveying (sub scanning) of a recording sheet S such as ordinary recording paper, special paper or an OHP film and selectively discharging ink from the recording head 201 in synchronization with these motions for deposition on the recording sheet S.

Referring to FIG. 1, the recording head 201 is detachably mounted on a carriage 202 slidably supported by two guide rails and reciprocated along the guide rails by drive means such as an unrepresented motor. The recording sheet S is conveyed in a direction crossing the moving direction of the carriage 202 (for example in a perpendicular direction A) by a conveying roller 203 so as to be opposed to the ink discharge face of the recording head 201 and to maintain a constant distance to the ink discharge face.

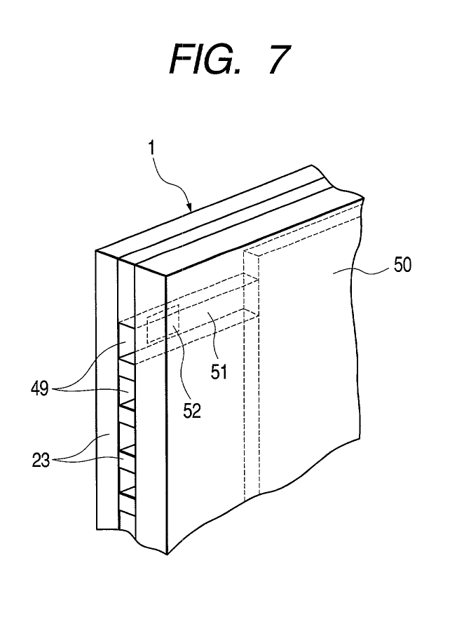

FIG. 7 is a partial perspective view schematically showing the structure of an ink discharge portion (an array of discharge ports) of the recording head 1. Referring to FIG. 7, a discharge port face 23, opposed to the recording material such as recording paper with a predetermined gap thereto (for example about 0.2 to 0.3 mm), is provided with plural discharge ports 49 formed at a predetermined pitch, and an electrothermal converting member (for example heat generating resistor) 52 for generating ink discharging energy is provided along the wall of each liquid path 51 connecting a common liquid chamber 50 and each discharge port 49. The recording head 1 is supported and guided in such positional relationship that the discharge ports 49 are arranged in a direction crossing the main scanning direction (moving direction of the carriage). In the recording head 1 thus constructed, the electrothermal converting member 52 is selectively driven by an image signal or a discharge signal (by the application of a pulse signal) to induce film boiling of the ink in the liquid path 51, thereby discharging the ink from the discharge port 49 by the generated pressure.

The recording head 201 is provided with plural nozzle arrays for discharging inks of respectively different colors (for example black, cyan, magenta and yellow). Such nozzle arrays are substantially perpendicular to the main scanning direction. Corresponding to the ink colors discharged from the recording head 201, plural independent main tanks (ink tanks) 204 are detachably mounted on the ink supply unit 205. The ink supply unit 205 and the recording head 201 are connected by plural ink supply tubes 206 respectively corresponding to the ink colors, and the mounting of the main tanks 204 on the ink supply unit 205 enables to independently supply the nozzle arrays of the recording head 201 with the inks of respective colors contained in such main tanks 204.

In a non-recording area within the movable range of the recording head 201 but outside the passing range of the recording sheet S, there is provided a recovery unit 207 so as to be opposed to the ink discharge face of the recording head 201. The recovery unit 207 serves to suck ink or bubble forcedly from the discharge nozzles of the recording head 201, thereby cleaning the nozzles.

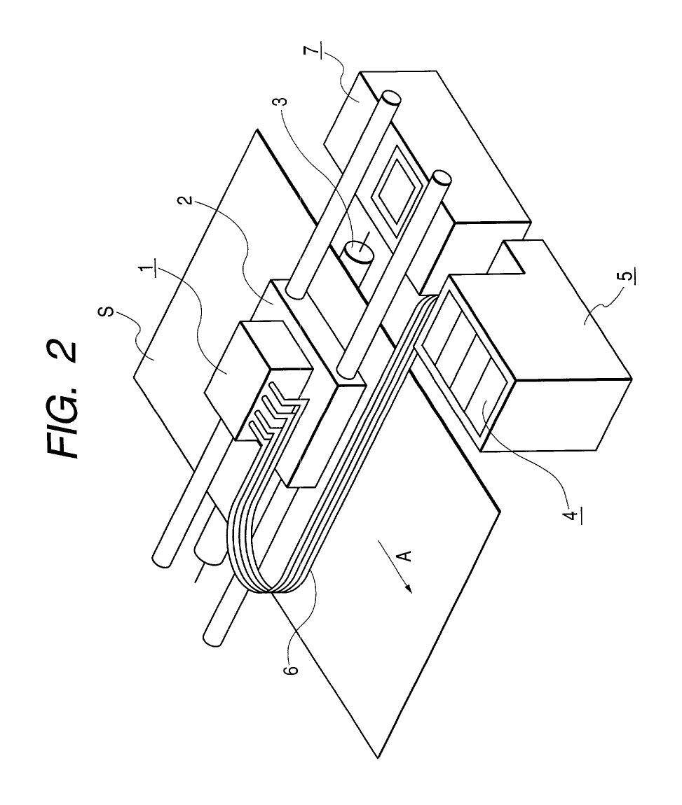

In the following there will be briefly explained, with reference to FIG. 2, the basic principle of ink supply in the above-described ink jet recording apparatus.

The recording head 201 and the main tank 204 L1 are connected by the ink supply tube 206 to constitute the ink supply path, which is filled with ink 209. The recording head 201 is so positioned that the position of the nozzle 201g is higher than the liquid level of the main tank 204 by a height H whereby the interior of the recording head 201 is maintained at a negative pressure corresponding to the water head of the height H. Such negative pressure maintains an ink meniscus formed at the front end of the nozzle 201g of the recording head 201. In this manner there is prevented ink leakage from the nozzle 201g and air intrusion therein. When ink is discharged from the nozzle 201g, the ink amount in the recording head 201 decreases to temporarily increase the negative pressure thereby retracting the meniscus, but the ink is then filled in the nozzle 201g by the capillary force thereof, whereupon the ink 209 is sucked up from the main tank 204 through the ink supply tube 306 to restore the pressure in the recording head 201, thereby stabilizing the meniscus at the front end of the nozzle 201g. Such ink discharge and ink supply (refilling) are repeated. The ink jet recording apparatus of the present embodiment is based on such basic principle.

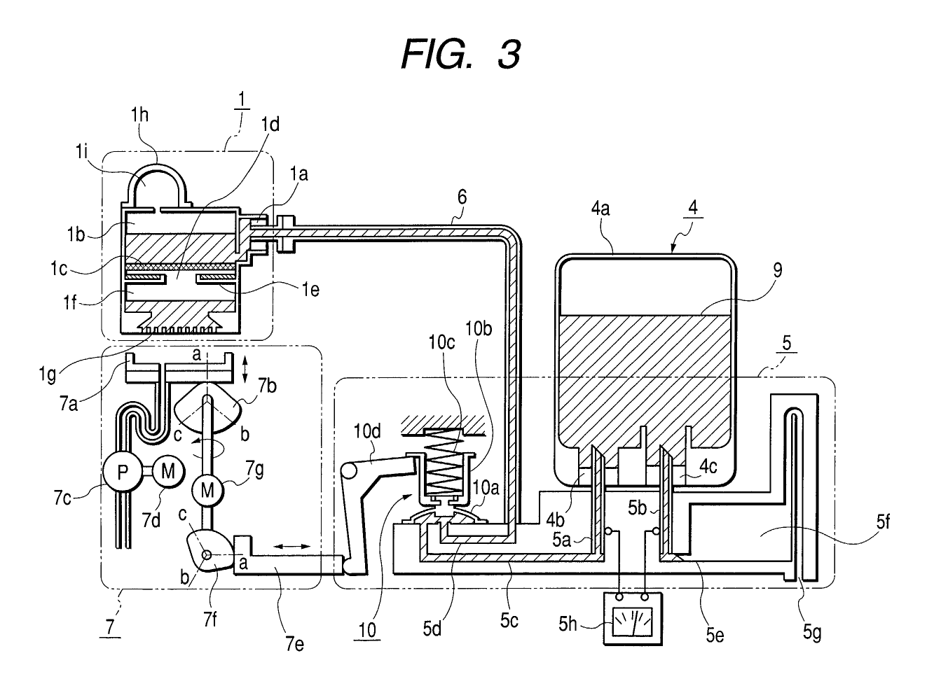

In the following there will be explained, with reference to FIG. 3, the detailed configuration of the ink supply system of the present ink jet recording apparatus. FIG. 3 shows the ink supply path of the ink jet recording apparatus shown in FIG. 1, illustrating the path for one color only for the purpose of simplicity.

At first there will be given an explanation on the recording head 201. The ink is supplied to the recording head 201, from a connector insertion port 201a which is hermetically connected to a liquid connector provided at the front end of the ink supply tube 206. The connector insertion port 201a communicates with a sub tank (first liquid chamber) 201b formed in the upper part of the recording head 201. Below the sub tank 201b in the direction of gravity, there is formed a liquid chamber (second liquid chamber) 201f for direct supply of the ink to a nozzle portion having plural nozzles 201g arranged in parallel manner. The sub tank 201b and the liquid chamber 201f are separated by a filter 201c. At the boundary between the sub tank 201b and the liquid chamber 201f there is provided a partition portion 201e including an aperture 201d, and the filter 201c is placed on such partition portion 201e.

In the above-described configuration, the ink supplied from the connection insertion port 201a to the recording head 201 is supplied through the sub tank 201b, filter 201c and liquid chamber 201f to the nozzle 201g. The path from the connection insertion port 201a to the nozzle 201g is maintained in a state closed to the external air.

The upper face of the sub tank 201b is provided with an aperture which is covered by a dome-shaped elastic member 201h. A space surrounded by the elastic member 201h constitutes a pressure adjusting chamber 201i, of which volume changes according to the pressure in the sub tank 201b for adjusting the pressure therein as will be explained later.

The nozzle 201g has a tubular structure of a cross-sectional width of about 20 μm and discharges ink by giving discharge energy to the ink in the nozzle 201g, and, after the ink discharge, the ink is filled in the nozzle 201g by the capillary force thereof. Normally the ink discharge is repeated with a frequency of 20 kHz or higher to achieve high-definition image formation at a high speed. In order to give the discharge energy to the ink in the nozzle 201g, the recording head 201 is provided with energy generation means in each nozzle 201g. The present embodiment employs, as the energy generation means, a heat generating resistor element for heating the ink in the nozzle 201g. An instruction from a head control unit (not shown) for controlling the recording head 201 selectively drives the heat generating resistors to induce film boiling of the ink the desired nozzles 201g, thereby discharging ink from the nozzles 201g utilizing the pressure of a bubble generated by such film boiling.

The nozzle 201g is arranged with the ink discharging front end thereof downwards, but is not provided with a valve mechanism for closing such front end, and the ink fills the nozzle 201g by forming a meniscus. For this purpose, the interior of the recording head 201, particularly that of the nozzle 201g, is maintained at a negative pressure. However, if the negative pressure is excessively small, the ink meniscus may be broken by the deposition of dusts or ink at the front end of the nozzle 201g thereby resulting in ink leakage from the nozzle 201g. On the other hand, if the negative pressure is excessively large, the force retracting the ink into the nozzle 201g becomes larger than the energy given to the ink at the discharge, thereby resulting in a discharge failure. Therefore, the negative pressure in the nozzle 201g is maintained within a certain range somewhat lower than the atmospheric pressure. Such negative pressure, though dependent on the number and cross section of the nozzles 201g and the performance of the heat generating resistor, is preferably within a range from −40 mmAq (about −0.0040 atm=−4.053 kPa) to −200 mmAq (about −0.0200 atm=−2.0265 kPa) (wherein the specific gravity of ink being assumed equal to that of water) according to the experimental results of the present inventors.

In the present embodiment, the ink supply system 205 and the recording head 201 are connected by the ink supply tube 206 and the position of the recording head 201 relative to the ink supply unit 205 can be relatively freely selected, so that the recording head 201 is positioned higher than the ink supply unit 205 in order to maintain the interior of the recording head 201 at a negative pressure.

The filter 201c is provided in order to prevent leak of a substance that may clog the nozzle 201g, from the sub tank 201b to the liquid chamber 201f. The area of the filter 201c is so selected that the pressure loss on the ink does not exceed a certain tolerance value. The pressure loss becomes higher as the mesh of the filter 201c becomes finer or the ink flow rate becomes higher, and is inversely proportional to the area of the filter 201c. In the recent recording apparatus of a high speed with multiple nozzle and with small recorded dots, the pressure loss tends to become higher, thus requiring a large filter of a size of about 10×20 mm. Accordingly there are also required large spaces in the sub tank 201c at the upstream side of the filter 201c and in the liquid chamber 201f at the downstream side of the filter 201c. The upper surface of the filter 201c is in contact with the ink in the sub tank 201b, and such contact area with the ink constitutes the effective area of the filter 201c. The pressure loss in the filter 201c is dependent on the effective area thereof. In the present embodiment, the filter 201c is positioned horizontally in the operational state of the recording head 201, and the entire upper surface of the filter 201c is maintained in contact with the ink to maximize the effective area of the filter, thereby lowering the pressure loss.

The filter 201c has such a property that, when brought into contact with ink, each fine hole forms a meniscus of the ink by the capillary force, whereby the ink permeation is easy but the air flow through the filter becomes difficult. As the fine hole becomes smaller, the meniscus strength becomes larger and the air flow becomes more difficult.

In such filter 201c as employed in the present embodiment, the pressure required for passing air is about 0.1 atm (10.1325 pKa: experimental value). Therefore, if air is present in the liquid chamber 201f, present in the downstream side of the filter 201c in the ink moving direction in the recording head 201, the air cannot pass the filter 201c by the floating force of the air itself, and the air in the liquid chamber 201f remains therein. The present embodiment utilizes this phenomenon in such a manner that the liquid chamber 201f is not completely filled with the ink but contains an air layer between the ink in the ink chamber 201f and the filter 201c, and the ink of a predetermined amount is contained in the liquid chamber 201f in such a manner that the air layer separates the ink in the liquid chamber 201f and the filter 201c.

Also if gas enters the nozzle 201g from the liquid chamber 201f, the nozzle 201g after ink discharge cannot achieve ink replenishment, thus inducing discharge failure. Consequently the interior of the nozzle 201g has to be always filled with the ink.

The pressure adjusting chamber 201i reduces its volume as the internal negative pressure increases, and can be composed, as in the present embodiment, of an elastic member 201h which is preferably composed of a rubber material or the like.

In the absence of the pressure adjusting chamber 201i, the pressure in the sub tank 201b is subjected directly to the resistance by the pressure loss when the ink goes through the main tank 204, ink supply unit 205 and ink supply tube 206. Therefore, in case of so-called high-duty ink discharge operation such as ink discharge from all the nozzles 201g, the ink amount supplied to the recording head 201 becomes deficient relative to the discharged ink amount, whereby the negative pressure increase rapidly. If the negative pressure of the nozzle 201g exceeds the aforementioned limit value of −200 mmAq (about −2.0265 kPa), the discharge becomes unstable and unsuitable for image formation.

In the recording apparatus of serial scan type as in the present embodiment, even in the image formation with a high duty ratio, the ink discharge is interrupted at the inversion of the drive of the carriage 202 (FIG. 1). The pressure adjusting chamber 201i performs a function, like a capacitor, of reducing the volume during the ink discharge to relax the increase in the negative pressure in the sub tank 201b and restoring the volume at the inversion of the movement of the carriage.

In the following there will be given an explanation on the ink supply unit 205 and the main tank 204.

The main tank 204 is constructed detachably mountable on the ink supply unit 205 and is provided, on the bottom portion thereof, with an ink supply aperture tightly closed with a rubber stopper 204b and an air introducing aperture tightly closed with a rubber stopper 204c. The main tank 204 is singly an air-tight container, and the ink 209 is contained in the main tank 204 in liquid state.

On the other hand, the ink supply unit 205 is provided with an ink supply needle 205a for extracting ink 209 from the main tank 204, and an air introducing needle 205b for introducing air into the main tank 204. The ink supply needle 205a and the air introducing needle 205b are both hollow needles and are positioned, with the front ends upwards, corresponding to the ink supply port and the air introducing port of the main tank 204. When the main tank 204 is mounted on the ink supply unit 205, the ink supply needle 205a and the air introducing needle 205b respectively penetrate the rubber stoppers 204b, 204c, thus entering the interior of the main tank 204.

The ink supply needle 205a is connected, through a liquid path 205c, a shut-off valve 210 and a liquid path 205d, to the ink supply tube 206. The air introducing needle 205b is connected, through a liquid path 205e, a buffer chamber 205f and an air communicating aperture 205g, to the external air. The ink supply needle 205a and the air introducing needle 205b in the present embodiment are composed of thick needles of an internal diameter of 1.6 mm.

The shut-off valve 210 is provided with a rubber diaphragm 210a which is displaced to open or close the connection between the two liquid paths 205c, 205d. On the upper surface of the diaphragm 210a, there is mounted a tubular spring holder 210b containing therein a compression spring 210c which serves to press the diaphragm 210a thereby closing the connection between the liquid paths 205c, 205d. The spring holder 210b is provided with a flange, engaging with a lever 210d to be operated by a link 207e of the recovery unit 207 to be explained later. By activating the lever 210d to lift the spring holder 210b against the spring force of the compression spring 210c, the connection between the liquid paths 205c, 205d is opened. The shut-off valve 210 is opened during the ink discharge from the recording head 201 but is closed during a stand-by state or in a non-operated state, and is opened and closed in synchronization with the recovery unit 207 during an ink filling operation to be explained later.

The above-described configuration of the ink supply unit 205 is provided for each main tank 204, namely for each ink color, except for the lever 210d. The lever 210d is provided common to all colors and simultaneously opens or closes the shut-off valves 210 for all the colors.

In the above-described configuration, when the ink is consumed in the recording head 201, the resulting negative pressure causes the ink to be from time to time supplied from the main tank 204 to the recording head 201 through the ink supply unit 205 and the ink supply tube 206. At this operation, air of an amount same as that of the supplied ink from the main tank 204 is introduced into the main tank 204 from the air communicating aperture 205g through the buffer chamber 205f and the air introducing needle 205b.

The buffer chamber 205f provides a space for temporarily holding the ink flowing out of the main tank 204 by the inflation of gas in the main tank 204, and the lower end of the air introducing needle 205b is positioned at the bottom of the buffer chamber 205f. In case the air in the main tank 204 inflates by an increase in the ambient temperature or a decrease in the external pressure during a stand-by state or a pause of the ink jet recording apparatus, since the shut-off valve 210 is closed, the ink in the main tank 204 flows out to the buffer chamber 205f through the air introducing needle 205b and the liquid path 205e. On the other hand, the air in the main tank 204 contracts for example by a decrease in the ambient temperature, the ink flowing out in the buffer chamber 205f returns to the main tank 204. Also in case the recording head discharges ink while the ink is present in the buffer chamber 205f, at first the ink in the buffer chamber 205f returns to the main tank 204 and the air is introduced into the main tank 204 after the ink in the buffer chamber 205f is depleted.

The volume Vb of the buffer chamber 205f is so selected as to satisfy the environmental use condition of the product. For example, for a product to be used within a temperature range of 5° C. (278° K.) to 35° C. (308° K.), and for a main tank 204 having a volume of 100 ml, the volume Vb is selected as 100×(308−278)/308=9.7 ml or larger.

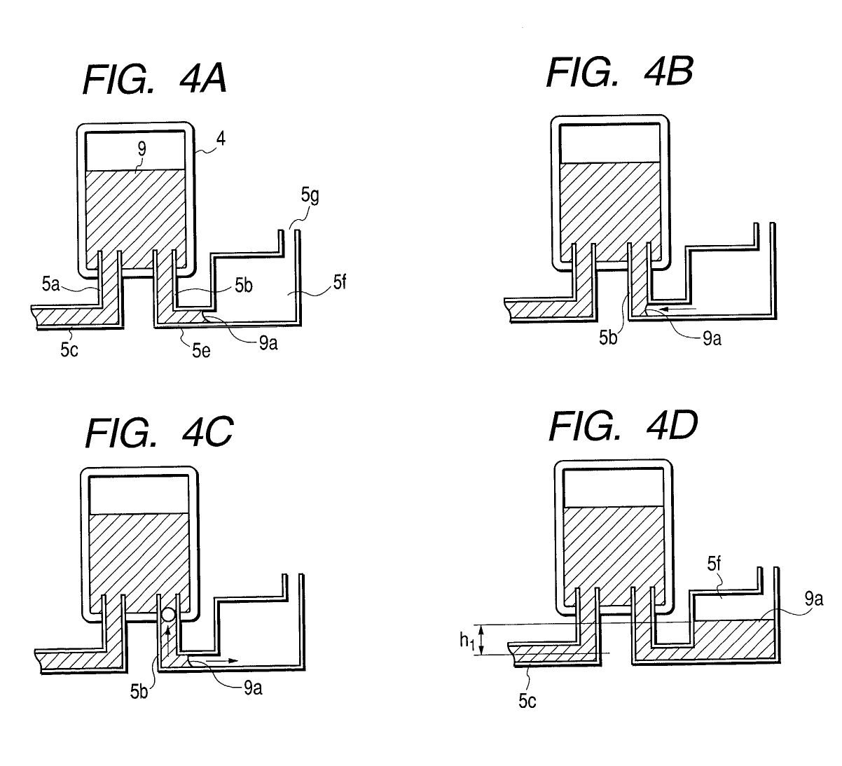

Now there will be explained, with reference to FIGS. 4A to 4D, the basic water head of the main tank 204 and the behavior of air and ink in the liquid path of the ink supply unit 205 at the gas introduction into the main tank 204.

FIG. 4A shows a normal state capable of ink supply from the main tank 204 to the recording head 201 (cf. FIG. 3). In this state, the interior of the main tank 204 is maintained air-tight except for the buffer chamber 205f and is maintained at a negative pressure relative to the atmospheric pressure, and the front end 209a of the ink remains in the liquid path 205e. The front end 209a of the ink is in contact with air and is therefore at the atmospheric pressure (=0 mmAq). The liquid path 205c in which the front end 209a of the ink is positioned and the liquid path 205e communicating with the ink supply tube 205 (cf. FIG. 3) are of a same height and mutually communicate only through the ink, so that the pressure of the liquid path 205e is also the atmospheric pressure. This pressure is determined only by the height relationship of the front end 209a of the ink and the liquid path 205c and is not influenced by the amount of ink 209 in the main tank 204.

As the ink in the main tank 204 is consumed, the front end 209a of the ink gradually moves toward the air introducing needle 205b as shown in FIG. 4B, and, upon reaching a position directly below the air introducing needle 205b, the air floats as a bubble in the air introducing needle 205b as shown in FIG. 4C and is introduced into the main tank 204. In return, the ink in the main tank 204 enters the interior of the air introducing needle 205b, whereby the front end 209a of the ink returns to the original state shown in FIG. 4A.

FIG. 4D shows a state where ink is accumulated in the buffer chamber 205f. In this state, the front end 209a of the ink is at a position in the middle of the height of the buffer chamber 205f and higher than the liquid path 205c by h1 (mm) so that the pressure in the liquid path 205c is −h1 (mmAq).

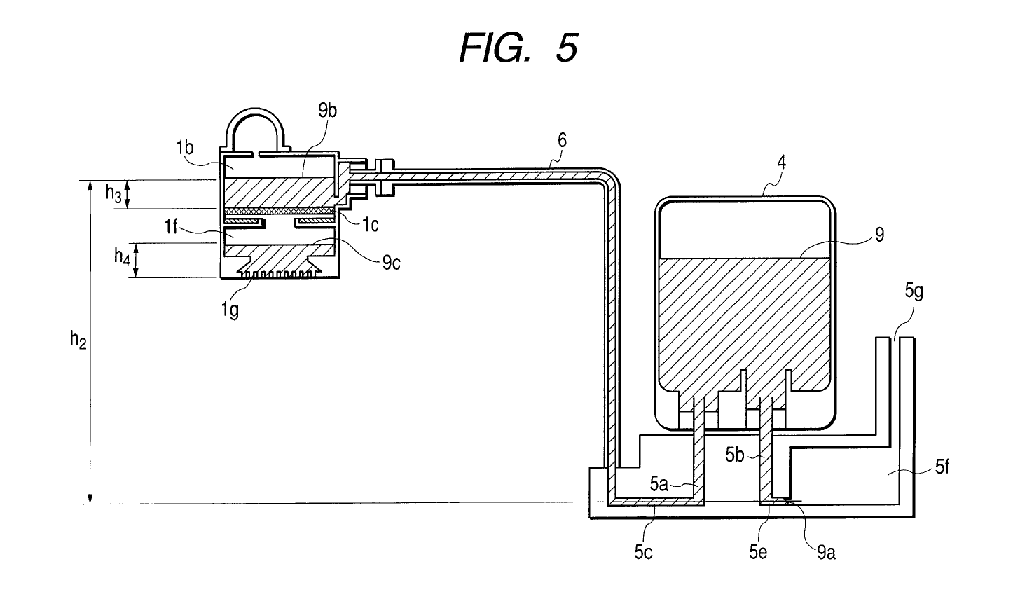

Thus, in the present embodiment, the negative pressure Pn applied to the lower end of the nozzle 201g (cf. FIG. 3) by the water head is Pn≈−9.8×(h2−h3−h4)Pa in the normal state or −9.8×(h2−h1−h3−h4)Pa in a state where the ink is accumulated in the buffer chamber 205f, wherein h2 (mm) is the height from the liquid path 205c to the upper face 209b in the sub tank 201b as shown in FIG. 5, h3 (mm) is the height from the filter 201c to the upper surface 209b of the ink in the sub tank 201b and h4 (mm) is the height from the lower end of the nozzle 201g to the upper surface 209c of the ink in the liquid chamber 201f. The value Pn is so selected as to be contained within the aforementioned negative pressure range of (−4.053 to −2.0265 kPa).

Again referring to FIG. 3, the ink supply needle 205a and the air introducing needle 205b are connected to a circuit 205h for measuring the electrical resistance of the ink, thereby detecting the presence or absence of ink in the main tank 204. The circuit 205h detects an electrically closed state in the presence of ink in the main tank 204 since a current flows in the circuit 205h through the ink in the main tank 204, but an electrically open state in the absence of ink or in case the main tank 204 is not mounted. Since the detected current is very weak, the insulation between the ink supply needle 205a and the air introducing needle 205b is important. In the present embodiment, the path from the ink supply needle 205a to the recording head 201 is made completely independent from the path from the air introducing needle 205b to the air communicating aperture 205g, whereby it is rendered possible to measure the electrical resistance of the ink only in the main tank 204.

In the following there will be given an explanation on the recovery unit 207. The recovery unit 207 serves to suck ink and air from the nozzle 201g and to operate the shut-off valve 210, and is provided with a suction cap 207a for capping the ink discharge face (containing aperture of the nozzle 201g) of the recording head 201, and a link 207e for operating the lever 210d of the shut-off valve 210.

The suction cap 207a is composed of an elastic member such as of rubber at least in a portion coming into contact with the ink discharge face, and is rendered movable between a position for tightly closing the ink discharge face and a position retracted from the recording head 201. The suction cap 207a is connected to a suction pump 207c, which is driven by a pump motor 207d to execute suction through the suction cap 207a. The suction pump 207c is composed of a tube pump having plural rollers capable of continuous suction and varying the suction amount by changing the revolution of the pump motor 207d. The present embodiment employs a suction pump 207c capable of reducing pressure to −0.4 atm (40.53 kPa).

A link 207e slides by a cam 207f to actuate the lever 210d of the shut-off valve 210, thereby opening or closing the same. Cams 207b, 207f are positioned coaxially and can rotate in a direction indicated by an arrow by a cam control motor 207g. The timing of the cam 207b coming into contact with the suction cap 207a in the positions a to c corresponds to the timing of the cam 207f coming into contact with the link 207e in the positions a to c. In the position a, the cam 207b separates the suction cap 207a from the ink discharge face of the recording head 201, and the cam 207f presses the link 207e to elevate the lever 210d, thereby opening the valve 210. In the position b, the cam 207g brings the suction cap 207a in contact with the ink discharge face, and the cam 207f pulls back the link 207e to close the valve. In the position c, the cam 207b brings the suction cap 207a in contact with the ink discharge face, and the cam 207f presses the link 207e to open the valve.

In the recording operation, the cams 207b, 207f are maintained in a state of the position a to enable ink discharge from the nozzle 201g and ink supply from the main tank 204 to the recording head 201. In a non-operating state including a stand-by state and a pause, the cams 207b, 207f are maintained in a state of the position b to cover the nozzle face of the recording head 1 by the suction cap 207a thereby preventing drying of the nozzle 201g and to prevent ink flow-out from the recording head 201 (particularly in case the apparatus itself is moved, the apparatus may be inclined to induce ink flow-out). The position c of the cams 207b, 207f is employed in an ink filling operation to the recording head 201 to be explained later.

In the foregoing there has been explained the ink supply path from the main tank 204 to the recording head 201, but the configuration shown in FIG. 3 eventually results in air accumulation in the recording head 201 over a prolonged period.

In the sub tank 201b, there are accumulated air permeating through the ink supply tube 206 and the elastic members 201h, and air dissolved in the ink. The air permeating through the ink supply tube 206 and the elastic member 201h can be prevented by employing a material of high gas barrier property, but such material is expensive. In the mass produced consumer equipment, it is not easy to use a high-performance material in consideration of the cost. In the present embodiment, the ink supply tube 206 is composed of a polyethylene tube of low cost and high flexibility, and the elastic member 201h is composed of butyl rubber.

On the other hand, in the liquid chamber 201f, there is gradually accumulated air, because of a phenomenon that the bubble generated at the ink discharge from the nozzle 201g causes fissure and returns to the liquid chamber 201f, or a phenomenon that the fine bubbles present in the ink gather to form a larger bubble by an increase of the ink temperature in the nozzle 201g.

According to the experiment of the present inventors, in the configuration of the present embodiment, the air accumulates by about 1 ml/month in the sub tank 201b and about 0.5 ml/month in the liquid chamber 201f.

The air accumulation in the sub tank 201b and the liquid chamber 201f, if large, reduces the ink amounts therein. In the sub tank 201b, an ink deficiency causes exposure of the filter 201c to the air to reduce the effective area thereof, thereby increasing the pressure loss thereof and eventually disabling ink supply to the liquid chamber 201f. Also an ink deficiency in the liquid chamber 201f causes exposure of the upper end of the nozzle 201g to the air, thereby rendering ink supply thereto difficult. In this manner, a fatal situation arises unless each of the sub tank 201b and the liquid chamber 201f contains ink at least equal to a predetermined amount.

Therefore, by filling each of the sub tank 201b and the liquid chamber 201f with an appropriate amount of ink at a predetermined interval, the ink discharging performance can be stably maintained over a long period, even without employing the material of high gas barrier property. For example, in the present embodiment, the sub tank 201b and the liquid chamber 201f may be filled with ink every month by an amount equal to the accumulating air amount per month plus fluctuation in the filling.

The ink filling into the sub tank 201b and the liquid chamber 201f is executed utilizing the suction operation by the recovery unit 207. More specifically, the suction pump 207c is activated in a state where the ink discharge face of the recording head 201 is tightly closed by the suction cap 207a, thereby sucking the ink in the recording head 201 from the nozzle 201g. However, in simple ink suction from the nozzle 201g, ink of an amount approximately equal to the ink sucked from the nozzle 201g flows from the sub tank 201b into the liquid chamber 201f and ink of an amount approximately equal to that flowing out of the sub tank 201b flows from the main tank 204 into the sub tank 201b, so that the situation does not change much from the state prior to suction and the filling of ink of the appropriate amount cannot be achieved.

Therefore, in the present embodiment, in order to fill the sub tank 201b and the liquid chamber 201f separated by the filter 201c respectively with appropriate amounts of ink, the sub tank 201b and the liquid chamber 201f are reduced to a predetermined pressure utilizing the shut-off valve 210, thereby setting the volumes of the sub tank 201b and the liquid chamber 201f.

In the following there will be explained the ink filling operation of the sub tank 201b and the liquid chamber 201f, and the volume setting thereof.

In the ink filling operation, at first the carriage 202 (cf. FIG. 1) is moved to a position where the recording head 201 is opposed to the suction cap 207a, and the cam control motor 207g of the recovery unit 207 is activated to rotate the cams 207b, 207f to a state where the position b for respective contacts with the suction cap 207a and the link 207e. Thus the ink discharge face of the recording head 201 is closed by the suction cap 207a, and the shut-off valve 210 closes the ink path from the main tank 204 to the recording head 201.

The pump motor 207d is activated in this state to execute suction by the suction pump 207c from the suction cap 207a. This suction operation sucks ink and air, remaining in the recording head 201, through the nozzle 201g, thereby reducing the pressure in the recording head 201. The suction pump 207c is stopped when the suction reaches a predetermined amount, and the cam control motor 207g is activated to rotate the cams 207b, 207f to a state where the position c is in contact with the suction cap 207a and the link 207e. Thus the ink discharge face remains in the closed state by the suction cap 207a but the shut-off valve 210 is opened. The suction amount of the suction pump 207c is so selected as to bring the interior of the recording head 201 to a predetermined pressure, and can be determined by calculation or by experiment. As the internal pressure of the recording head 201 is reduced, ink flows into the recording head 201 through the ink supply tube 206, thereby filling each of the sub tank 201b and the liquid chamber 201f with ink. The amount of ink filling corresponds to a volume required for returning the sub tank 201b and the liquid chamber 201f to the atmospheric pressure, and is determined by the volume and pressure thereof.

The ink filling into the sub tank 201b and the liquid chamber 201f is completed in about 1 second after the opening of the shut-off valve 210. Upon completion of the ink filling, the cam control motor 207g is driven to rotate the cams 207g, 207f to a state where the position b is in contact with the suction cap 207a and the link 207e. In this manner the suction cap 207a is separated from the recording head 201, and the suction pump 207c is activated again to suck the ink remaining in the suction cap 207a. As the shut-off valve 210 is open in this state, the recording head 201 is in a state capable of discharging ink to form a character or an image on the recording sheet S (cf. FIG. 1). In a stand-by state or in a pause state, the cam control motor 207g is activated again to rotate the cams 207b, 207f to a state where the position b is in contact with the suction cap 207a and the link 207e, thereby closing the ink discharge face of the recording head 201 with the suction cap 207a and closing the shut-off valve 210.

Unless the ink in the sub tank 201b and the liquid chamber 201f becomes deficient over a long period, it is not necessary to frequently execute the suction operation by the recovery unit 207, so that the chances of wasting ink can be reduced. Also the ink filling, if required in both of the sub tank 201b and the liquid chamber 201f, can be achieved in a single filling operation, thereby allowing to economize the ink.

In the following there will be given an explanation on the aforementioned filling operation and volume setting.

Now, let us consider the relationship among the volume V1 of the sub tank 201b, the ink amount S1 to be filled therein and the pressure P1 (relative to the atmospheric pressure) therein. Based on the law “PV=constant”, the sub tank 201b can be filled with the ink of an appropriate amount in the filling operation, by setting a relation V1=S1/|P1|. Similarly, for the volume V2 of the liquid chamber 201f, the ink amount S2 to be filled therein and the pressure P2 (relative to the atmospheric pressure) therein, the liquid chamber 201f can be filled with the ink of an appropriate amount in the filling operation, by setting a relation V2=S2/|P2|.

Also the filter 201c separating the sub tank 201b and the liquid chamber 201f has a fine mesh structure and the air flow therein is difficult in a state having a meniscus therein, as explained in the foregoing. For a pressure Pm required for air permeation through the filter 201c having such meniscus, in case of suction from the nozzle 201g by the recovery unit 207, the pressure P2 in the liquid chamber 201f becomes lower by Pm than the pressure P1 in the sub tank 201b since the air has to come from the sub tank 201f through the filter 201c. Thus, by employing this relationship in determining the volumes of the sub tank 201b and the liquid chamber 201f, the condition of the filling operation can be easily determined.

In the following there will be explained specific examples of the aforementioned filling operation and the volume setting. In the present embodiment it is assumed that the ink filling is executed every month, and the air accumulating amount per month is 1 ml in the sub tank 201b and 0.5 ml in the liquid chamber 201f. It is also assumed that the ink amount required in the sub tank 201b not to expose the filter 201c to air is 0.5 ml while the ink amount required in the liquid chamber 201f not to expose the nozzle 201g to air is 0.5 ml, and the fluctuation in the ink filling amount is 0.2 ml both in the sub tank 201b and the liquid chamber 201f. These values are determined experimentally. Thus the ink amount to be after the filling operation is the sum of these amounts, and is as large as 1.7 ml in the sub tank 201b and 1.2 ml in the liquid chamber 201f.

The reduced pressure in the recording head 201 is selected within the ability of the recovery unit 207. In the present embodiment, since the power limit of the suction pump 207c is −0.6 atm (−60.795 kPa), the suction amount of the suction pump 207c is experimentally so determined that the pressure in the suction cap 207a can reach −0.5 atm (−50.6625 kPa) with a certain margin, and is controlled by the revolution of the pump motor 207d.

As the pressure required for air permeation against the meniscus in the nozzle 201g is experimentally −0.05 atm (−5.06625 kPa), there is generated a difference between the pressures of the suction cap 207a and the liquid chamber 201f by the resistance of the nozzle 201g, whereby the pressure in the liquid chamber 201f becomes higher than that in the suction cap 207a by 0.05 atm (5.06615 kPa). Similarly, as the pressure required for air permeation against the meniscus in the filter 201c is experimentally −0.1 atm (−10.1325 kPa), there is generated a difference between the pressures of the liquid chamber 201f and the sub tank 201b by the resistance of the filter 201c, whereby the pressure in the sub tank 201b becomes higher than that in the liquid chamber 201f by 0.1 atm (10.1325 kPa). Therefore, by setting the pressure in the suction capo 207a at −0.5 atm (−50.6625 kPa), the pressure in the liquid chamber 201f becomes −0.45 atm (−45.5963 kPa) while that in the sub tank 201b becomes −0.35 atm (−35.4638 kPa).

In order to fill the sub tank 201b with ink of 1.7 ml, the volume V1 thereof is so selected that the internal pressure becomes −0.35 atm (−35.4638 kPa) when ink of 1.7 ml is sucked from the sub tank 201b having an internal pressure of about 1 atm (101.325 kPa). Thus, V1=1.7/0.35=4.85 ml. Similarly the volume V2 of the liquid chamber 201f can be determined as V2=1.2/0.45=2.67 ml.

After the internal pressure of the recording head 201 is reduced under the foregoing conditions, the shut-off valve 210 is opened whereby the ink flows into the recording head 201 in a reduced pressure state. More specifically, at first the ink flows into the sub tank 201b whereby the air inflated to the volume V1 under reduced pressure is restored almost to the atmospheric pressure. The air volume V1a in the sub tank 201b in such state is given by V1a=V1×(1−0.35)=3.15 ml, and the filling is terminated when ink in an amount of V1−V1a=1.7 ml is filled into the sub tank 201b. Similarly, in the liquid chamber 201f, the ink flows from the sub tank 201b whereby the air inflated to the volume V2 under reduced pressure is restored almost to the atmospheric pressure. The air volume V2a in the liquid chamber 201f in such state is given by V2a=V2×(1−0.45)=1.47 ml, and the filling is terminated when ink in an amount of V2−V2a=1.2 ml is filled into the liquid chamber 201f.

Thus, by setting the volumes and reduced pressures of the sub tank 201b and the liquid chamber 201f in the above-described manner, it is rendered possible to fill the sub tank 201b and the liquid chamber 201f, separated by the filter 201c, with the ink of appropriate amounts in a single filling operation, so that the recording head can be properly operated over a long period even in a situation where air is accumulated therein.

Also against the drawback that the bubble clogs the flow path between the filter and the nozzle, the cross sectional area of the liquid chamber 201f in the present embodiment is selected sufficiently large with respect to the diameter of the bubble that can exist in the liquid chamber 201f, so that the ink flow cannot be hindered by the bubble in the liquid chamber 201f. Furthermore, against the drawback that the bubble in the liquid chamber enters the nozzle or clogs the connection between the liquid chamber and the nozzle, the cross sectional area of the liquid chamber 201f is selected sufficiently large as explained in the foregoing, so that the bubble generated in the liquid chamber 201f rises by the floating force thereof in the ink and is united with the air layer, thereby being prevented from entering the nozzle 201g. Thus, by constructing the liquid chamber 201f separated from the sub tank 201b by the filter 201c in the above-described manner, it is rendered possible to significantly improve the reliability against the discharge failure resulting from the bubble generation in the liquid chamber 201f or from the movement of the generated bubble.

Also in case of constructing either of the sub tank and the liquid chamber in the configuration of the present embodiment and the other according to the background technology, there can be achieved the aforementioned function at least on the former and there can be obtained an advantage of achieving efficient air elimination.

In the foregoing description, it is assumed that the ink remains, even in a small amount, in the sub tank 201b and the liquid chamber 201f after the suction operation and that the sum of the remaining ink amount and the ink filling amount becomes appropriate, namely “ink amount to be present”=“remaining ink amount”+“ink filling amount”. However, in case the ink in the sub tank 201b or in the liquid chamber 201f is completely discharged by the suction operation, the ink amount to be present in the sub tank 201b or in the liquid chamber 201f coincides with the ink filling amount, so that “ink amount to be present” can be considered equal to “ink filling amount”.

1. An ink jet recording apparatus comprising:
a recording head including a discharge port for discharging ink, a first liquid chamber at the upstream side in the direction of ink flow toward said discharge port, and a second liquid chamber at the downstream side;
an ink tank for containing ink to be supplied to said recording head;
an ink supply tube for causing said ink tank to communicate with said recording head;
a shut-off valve provided in said ink supply tube and opening or closing said ink supply tube;
a cap for covering said discharge port; and
a suction pump for forcedly discharging the ink in said recording head from said discharge port when said cap covers said discharge port;
wherein said shut-off valve is opened when said first and second liquid chambers are reduced to respectively desired pressures by said suction pump in a state where said cap covers said discharge port and said shut-off valve is closed, whereby the ink in said ink tank is supplied through said ink supply tube to said first and second liquid chambers.

2. An ink jet recording apparatus according to claim 1, wherein at least either of said first and second liquid chambers has a volume determined from the suction force of said suction pump and the desired ink amount to be present after the suction by said suction pump.

3. An ink jet recording apparatus according to claim 2, wherein the volume V1 of said first liquid chamber is so selected as to substantially satisfy a relation V1=S1/|p1| in which p1 is the reduced pressure (atm) (relative value from the atmospheric pressure) of said first liquid chamber at the suction by said suction pump, and S1 is the ink amount to be present in said first liquid chamber.

4. An ink jet recording apparatus according to claim 2, wherein the volume V2 of said second liquid chamber is so selected as to substantially satisfy a relation V2=S2/|p2| in which p2 is the reduced pressure (atm) (relative value from the atmospheric pressure) of said second liquid chamber at the suction by said suction pump, and S2 is the ink amount to be present in said second liquid chamber.

5. An ink jet recording apparatus according to claim 1, further comprising a filter positioned between and separating said first and second liquid chambers.

6. An ink jet recording apparatus according to claim 5, wherein said filter has a mesh structure having plural pores.

7. An ink jet recording apparatus according to claim 1, wherein a pressure pm of the meniscus strength at each pore of said filter, a reduced pressure p1 (atm) (relative value from the atmospheric pressure) in said first liquid chamber at the suction by said suction pump and a reduced pressure p2 (atm) (relative value from the atmospheric pressure) in said second liquid chamber at the suction by said suction pump satisfy a relation p1=p2−pm;
the volume V1 of said first liquid chamber is so selected as to substantially satisfy a relation V1=S1/|p1| in which S1 is the ink amount to be present in said first liquid chamber; and
the volume V2 of said second liquid chamber is so selected as to substantially satisfy a relation V2=S2/|p2| in which S2 is the ink amount to be present in said second liquid chamber.

8. An ink jet recording apparatus according to claim 1, wherein the ink amounts to be respectively present in said first and second liquid chambers are larger than the air amounts to be respectively present in said first and second liquid chambers.

9. An ink jet recording apparatus according to claim 8, wherein the ink amounts to be respectively present in said first and second liquid chambers are larger than the sum of the air amounts respectively accumulating in said first and second liquid chambers and the minimum necessary ink amounts required for ensuring stable performance respectively in said first and second liquid chambers.

10. An ink jet recording apparatus according to claim 1, wherein said cap and said shut-off valve are driven by common drive means and move in mutual linkage.

11. An ink jet recording apparatus according to claim 10, wherein said drive means executes an operation of moving said cap to a capping position in which said cap covers said discharge port or to a retracted position in which said cap is retracted to open said discharge port, and an operation of opening or closing said shut-off valve.

12. An ink jet recording apparatus according to claim 11, further comprising a first cam for moving said cap and a second cam for opening or closing said shut-off valve, wherein said drive means is a motor for rotating said first and second cams on a same shaft.

13. An ink jet recording apparatus according to claim 1, further comprising a supply unit including a mounting portion on which said ink tank is to be detachably mounted, a first liquid path for connecting said ink tank mounted on said mounting portion to said shut-off valve, and a second liquid path for connecting a supply tube, for connecting said valve to said recording head, to said valve, and said shut-off valve, and detachable from the main body of the ink jet recording apparatus in a state holding the flow path from said first liquid path to said supply tube while said supply tube and said valve are in a mounted state, and said supply unit is positioned adjacent to said suction pump in said ink jet recording apparatus.

14. An ink jet recording apparatus according to claim 1, wherein said recording head includes an electrothermal converting member for generating thermal energy to be utilized for discharging ink from said discharge port.
